(19) United States
(12) Patent Application Publication
(10) Pub. No.: US 2015/0199736 A1
(43) Pub. Date: Jul. 16, 2015

(54) SYSTEMS AND METHODS FOR TICKET LISTING TRACKING

(71) Applicant: Suzy Kyunghi Chang, San Jose, CA (US)

(72) Inventor: Suzy Kyunghi Chang, San Jose, CA (US)

(21) Appl. No.: 14/152,958

(22) Filed: Jan. 10, 2014

(51) Int. Cl. G06Q 30/06; G06Q 20/04

(52) U.S. Cl. CPC G06Q 30/0601; G06Q 20/045

(57) ABSTRACT

A tracking log system can be provided in association with an online ticket marketplace that tracks ticket listings and the status of tickets associated with the listings. The system can be implemented as a logging server coupled to a ticket server and a last minute services (LMS) center. The system can maintain a listing log for each ticket listing. The logging server can update the listing log whenever any change is made to the listing and/or the status of the tickets. The logging server can update the listing log in response to changes the seller makes to the listing and in response to ticket activities at the LMS center. When tickets are received, sold, or provided to a buyer by the LMS center, the logging server can update the listing log to reflect the corresponding ticket status update. The listing log can be accessed by customer service representatives.

### BACKGROUND

1. Technical Field

The present disclosure relates generally to electronic commerce, and more particularly, to systems and methods for facilitating online selling and buying of tickets for ticketed events.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket market. Various online ticket sellers provide websites through which parties can buy and sell tickets online. These tickets can be obtained by a user to reserve seats and/or admission for a variety of live events, such as sporting events, concerts, theater events, and other entertainment events. Typically, a buyer looks for available tickets on a ticket marketplace website or other online listing and decides which, if any, of the available tickets are of interest to the buyer for possible purchase.

In some cases, a ticket owner may utilize an online ticket seller service to create a listing for publishing tickets for an upcoming event which are for sale. The listing commonly includes information about the tickets that are for sale and options for ticket delivery. In some scenarios, if care is not taken, an error can occur in a ticket listing. This type of listing error can be frustrating for a seller and/or a potential buyer and can reduce the effectiveness of a ticket seller service, thereby potentially causing reduced attendance at ticketed events.

It may therefore be desirable to provide systems and methods for avoiding and/or quickly resolving errors associated with the buying and selling of tickets for various ticketed events.

### BRIEF DESCRIPTION OF THE DRAWINGS

FIG. 1 is a block diagram of an illustrative computing system that is adapted for implementing the sale and purchase of tickets for ticketed events according to an embodiment.

FIG. 2 is a block diagram of an illustrative computer system suitable for implementing on one or more devices of the computing system in FIG. 1 according to an embodiment.

FIG. 3 is a block diagram of an illustrative system for facilitating the sale, purchase, and tracking of tickets for ticketed events according to an embodiment.

FIG. 4 is an illustrative flow diagram showing a logging server may be used to track ticket listing updates according to an embodiment.

FIG. 5 is an illustrative flow diagram showing a logging server may be used to track ticket status updates according to an embodiment.

FIG. 6 is a diagram of an illustrative listing log that may be used and updated for facilitating the sale, purchase, and tracking of tickets for ticketed events according to an embodiment.

FIG. 7 is a flowchart of an illustrative process that may be performed for tracking ticket listing and status activity according to an embodiment.

FIG. 8 is a flowchart showing an illustrative process that may be performed for resolving customer disputes using a listing log according to an embodiment.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online sale, purchase, and resale of tickets to ticketed events. In various particular embodiments, the devices, systems or methods can involve one or more devices in communication over a network. Such devices, systems, and methods can facilitate the sale and purchase of tickets to various ticketed events. In some embodiments, the sale and purchase of tickets may be facilitated by tracking activity associated with a ticket listing while the tickets are listed for sale. Activity associated with the listing (e.g., listing activity) and/or activity associated with the actual tickets (e.g., ticket status activity) can be monitored and logged in order to prevent and/or correct potential errors in the ticket sale and/or purchase process.

While the various examples disclosed herein focus on particular aspects regarding the online sale and/or purchase of tickets, it will be understood that the various inventive principles and embodiments disclosed herein can be applied to other types of ticketed applications and arrangements as well. For example, a ticket purchase that is performed in person or on a closed or proprietary computing system may utilize one or more of the aspects and features found in the various systems and methods provided.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

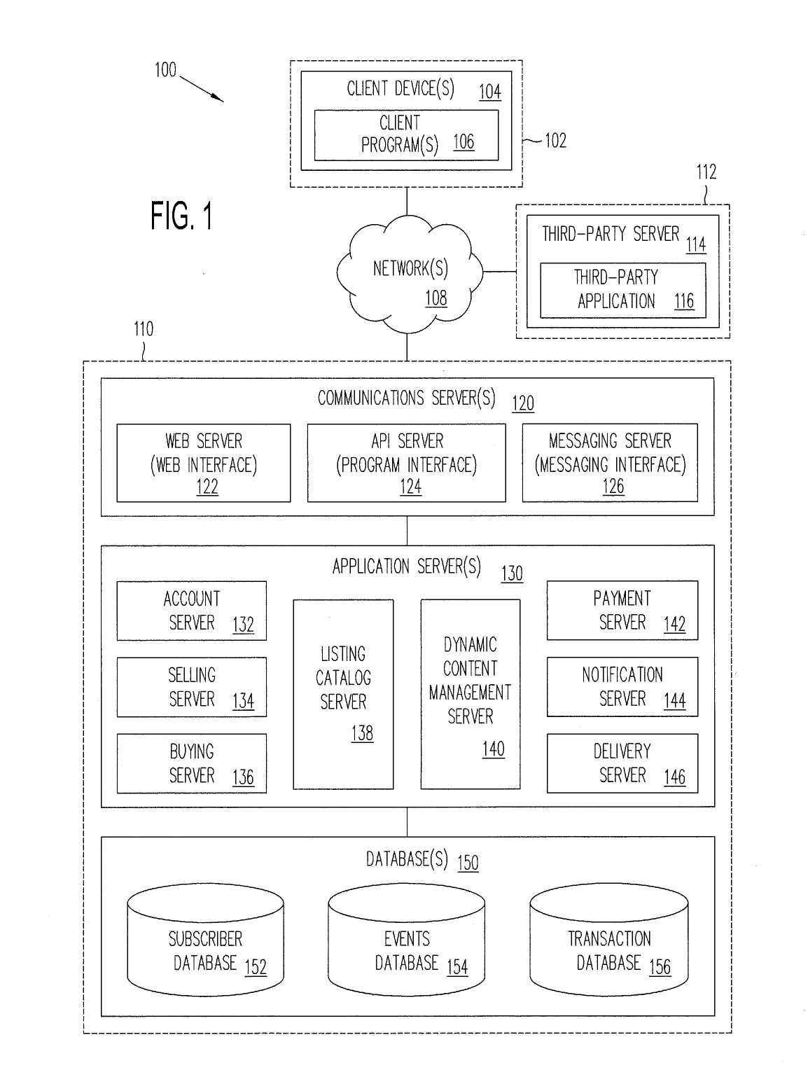

Beginning with FIG. 1, an exemplary embodiment of a computing system adapted for implementing the sale and purchase of tickets for ticketed events is illustrated in block diagram format. As shown, a computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for selection, sale, and/or purchase of tickets for a ticketed event) may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory. Third-party server 114 and/or third-party application 116 may provide system 110 and/or client 102 with email services and/or information, social networking services and/or information, purchase services and/or information, or other online services and/or information.

In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, delivery services, payment services, gathering services, location-based services, tracking services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

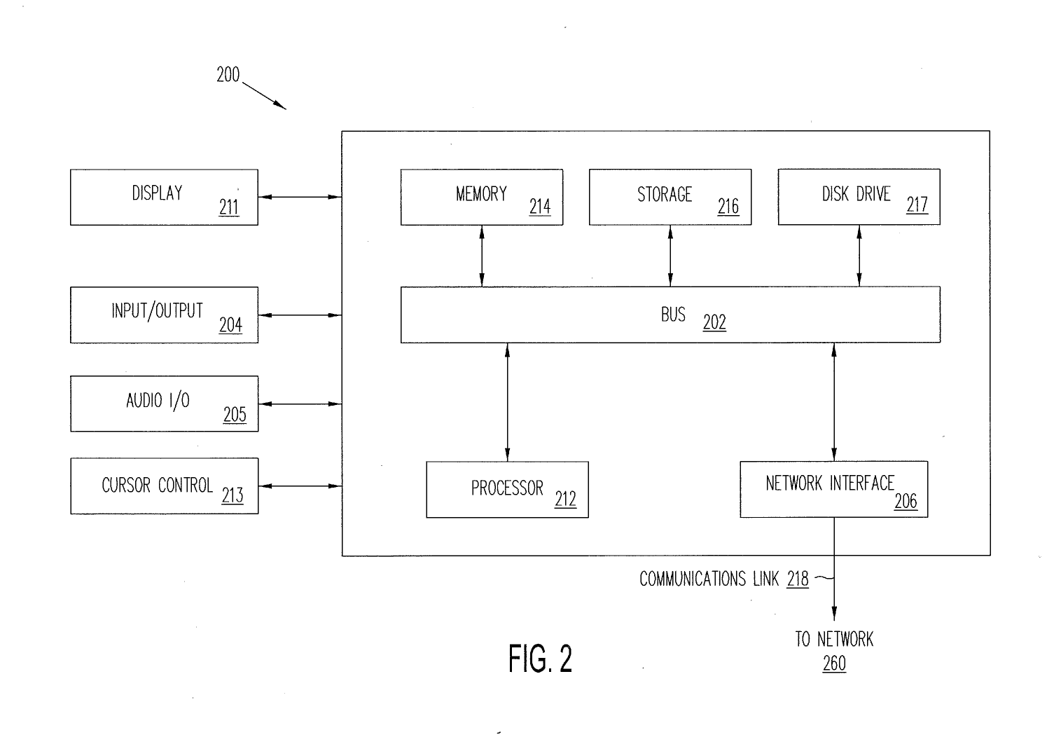

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server, an email server, a social networking server, a logging server, a last minute services server, a customer services server, other third-party servers, and/or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof can be used to implement a ticket listing, tracking, sale, and/or purchase operation according to various embodiments.

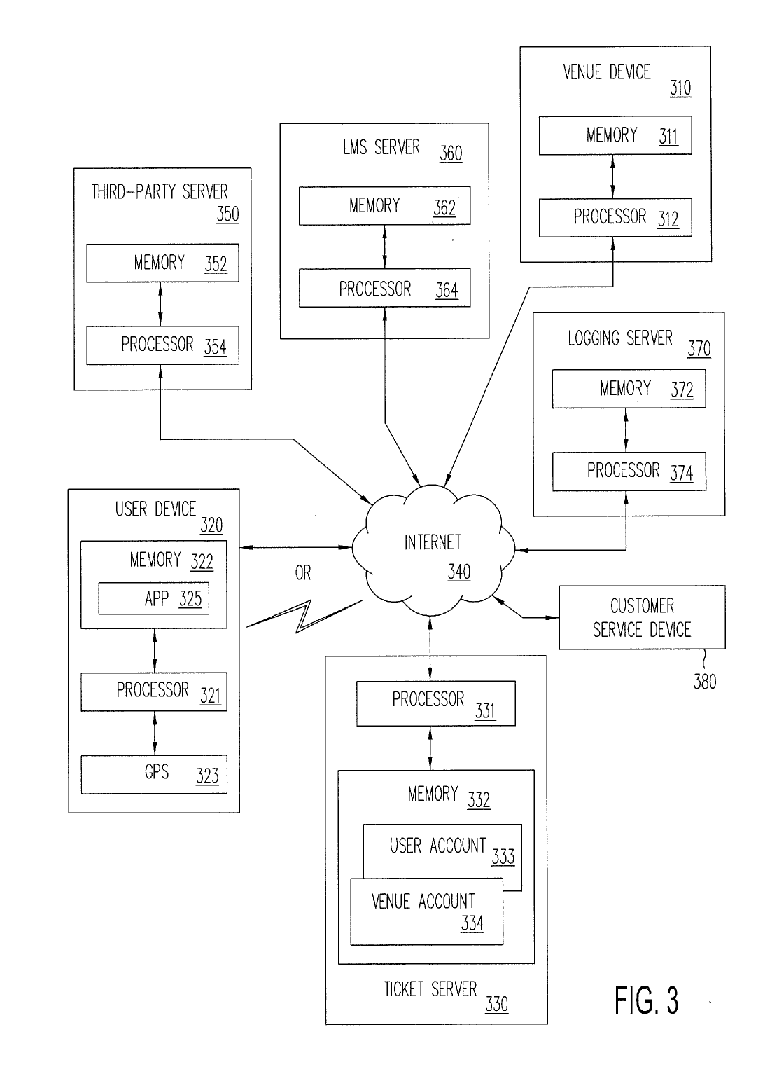

FIG. 3 is a block diagram showing a ticket sale, tracking, purchase, and fulfillment system that may be used to provide ticket listing services, listing tracking services, ticket tracking services, ticket purchase services, ticket fulfillment services, last minute services (LMS), and/or ticket-related customer service according to an embodiment. As shown in FIG. 3, a ticket server 330 may be in communication with one or more user devices such as user device 320, one or more venue devices such as venue device 310, one or more third-party servers such as third-party server 350, one or last minute services (LMS) servers such as LMS server 360, one or more logging servers such as logging server 370, and/or one or more customer service devices such as customer service device 380.

A user (e.g., a potential ticket buyer, a ticket buyer, or a ticket seller) can use a device such as a user device 320 to shop online for available tickets for one or more events, to select and purchase tickets for ticketed events from ticket server 330, to sell tickets for ticketed events, and/or to determine the status of a ticket listing and/or a ticket (as examples).

User device 320 can be a mobile device such as a cellular telephone, a tablet computer, a laptop computer, or another portable computing device. User device 320 can be a non-mobile device such as a home (land line) telephone, a desktop computer, an interactive set top box, or the like. User device 320 can be any device or combination of devices that facilitate online ticket purchasing. User device 320 may, for example, be an implementation of client device 104 of FIG. 1.

User device 320 can have a processor 321, a memory 322, a global positioning system component (GPS) 323 and/or other suitable device components. Processor 321 can execute an application such as an app 325 that facilitates the ticket sales, selection and/or purchase methods disclosed herein. App 325 can be stored in memory 322. App 325 can provide a graphical user interface (GUI) for the user when the user is selling, selecting, tracking, and/or purchasing tickets online. If desired, app 325 can be a dedicated ticket marketplace app. However, this is merely illustrative. In some configurations, app 325 can be part of another app, such as a Paypal, Inc. payment provider app.

User device 320 can communicate with venue device 310, third-party server 350, LMS server 360, customer service device 380, and/or ticket server 330 via a network. For example, user device 320 can communicate with venue device 310, third-party server 350, LMS server 360, customer service device 380, and/or ticket server 330 via the Internet 340. User device 320 can communicate with the Internet via either a wired connection or a wireless connection. App 325 may be configured to transmit to ticket server 330 location information of user device 320 and/or ticket listing, tracking, buying, and/or selling information. In some embodiments, ticket server 330 may have access to location information for a user based on location data from GPS 323.

Ticket server 330 may be operated by an online ticket seller such as StubHub, Inc. Ticket server 330 can facilitate online ticket sales. Ticket server 330 may include processing circuitry such as a processor 331 in communication with storage such as a memory 332. Processor 331 can include one or more processors. Processor 331 can access accounts such as a user account 333 and/or a venue account 334 that are stored in memory 332. User account 333 can include information regarding the user (e.g., identification information, preferences, account numbers, purchase history, social network contacts, email contacts, email account permissions, social media account permissions, purchased-ticket event information, attended event information, listing information, etc.). Venue account 334 can include information regarding the venue (e.g., information regarding events, seating, venue location, and other venue features). Memory 332 can be separate from the ticket server and can be used to store any number of user accounts 333, venue accounts 334, or other information for facilitating selling, tracking, and buying of tickets. Memory 332 can be distributed, e.g., have portions thereof disposed at a plurality of different locations. Other accounts may also be accessible by processor 331, such as accounts of users selling tickets that include ticket listing details, such as price, quantity, location, event information, and user information such as financial information that enables funds to be deposited into seller accounts when their tickets are sold.

Ticket server 330 may include one or more servers located at one or more locations. Thus, the ticket server 330 can be geographically and operationally distributed if desired. Ticket server 330 can be part of another system, such as a payment provider system.

Ticket server 330 can communicate with LMS server 360, logging server 370, and/or customer service device 380 over a wired or wireless connection such as via a network. For example, ticket server 330 can communicate with LMS server 360, logging server 370, and/or customer service device 380 via Internet 340.

Logging server 370 may be separate from ticket server 330 or may form a portion of ticket server 330. Logging server 370 may include computing equipment such as processor 374 and/or memory 372. Memory 372 and processor 374 may generate, store, and/or maintain a listing log associated with each ticket and/or set of tickets that are listed for sale using ticket server 330. For example, when a seller lists a ticket for sale using ticket server 330, ticket server 330 may transmit listing information to logging server 370. Logging server 370 may generate a listing log for that listing that includes the listing creating date, an identity of the seller, and/or other information associate with the listing. When the listing is updated (e.g., by the seller, by the ticket server, by LMS server 360, customer service device 380 and/or third party server 350), ticket server 330 may transmit listing update metadata to logging server 370 that can be aggregated and stored in order to track the status and changes to the status of a listing.

LMS server 360 may be a server of a last minute services affiliate of ticket server 330. LMS server 360 may be located remotely from ticket server 330 or may be partially or completely incorporated in ticket server 330. In one embodiment, an LMS server such as LMS server 360 may be located at a last minute services location that facilitates delivery of tickets of ticket sales that occur close to the start time of an associated ticketed event.

It can be appreciated that both sellers and buyers of tickets may desire the last available sale time to be as close to the event start time as possible in order to maximize the opportunity to make a sale and the opportunity to witness an event. Accordingly, the ticket server 330 and LMS server 360 may cooperate to provide sellers and buyers with various last minute services (LMS) for maintaining an event listing and the ability to sell and purchase listed tickets right up to the start of the event.

In one implementation, for example, ticket server 330 and LMS server 360 may allow tickets to be sold on consignment and may maintain an event listing until the start of the event. When a seller requires delivery of physical tickets for an upcoming event, the seller may select to sell the tickets using LMS provided by the ticket server 330 and LMS server 360. The seller may request LMS and provide the ticket server 330 and/or LMS server 360 with contact information (e.g., name, address, telephone number, e-mail address), ticket information (e.g., event name, event venue, ticket event dates, closest city to the event), and authorization to release the tickets.

In response to the LMS request, the seller may be contacted by an agent of ticket server 330 and/or LMS server 360 via telephone or other contact method and provided with additional selling information. Depending on the time remaining before the event, the seller may be instructed to ship or physically deliver the tickets to an LMS center associated with LMS server 360. Typically, the location of the LMS center will be in close proximity to the event venue. The seller also may select to physically deliver the tickets to the LMS center. When physical delivery of the ticket to the LMS center is required or selected, the seller may be provided with the location of the LMS center, driving or walking directions to the LMS center, and/or a map showing the LMS center.

Once the tickets are delivered to the LMS center, LMS server 360 may instruct ticket server 330 to activate and/or maintain an associated event listing until the start of the event and the subsequent delivery of the tickets to a buyer is handled by the LMS center. For example, the LMS center may handle the responsibility of shipping the tickets to the buyer, delivering the tickets to the event venue will call, and/or the keeping the tickets at the LMS center until pick-up by the buyer. It can be appreciated that the LMS provided by the ticket server 330 and LMS server 360 may facilitate delivery and allow ticket server 330 and LMS server 360 to defer the last sale time until the start of the event.

LMS server 360 may include processing circuitry such as processor 364 and storage such as memory 362. LMS server 360 may provide ticket status updates to ticket server 330 and/or logging server 370. For example, when an LMS center (e.g., using LMS server 360) provides ticket delivery information to a user, receives tickets from a user, and/or provides tickets to a buyer (as examples), LMS server 360 can transmit ticket status metadata describing that ticket activity to logging server 370 for storage and tracking in a listing log on the logging server.

Customer service device 380 may be any suitable device that can be used by a customer service center and/or customer service representative to handle customer service communications with buyers and sellers and/or access ticket listing information and/or ticket status information stored in a listing log by logging server 370. For example, when a seller contacts a customer service center to inquire about the status of a listing and/or tickets of the seller, a customer service agent and/or automated customer service device can use a computer, a smart phone, a tablet, or other suitable customer service device to look up the status and history of a listing and/or a ticket in the listing log for the listing associated with the ticket and/or the seller.

Venue device 310 and/or third-party server 350 can communicate with ticket server 330 over a wired or wireless connection such as via a network. For example, venue device 310 and/or third-party server 350 can communicate with ticket server 330 via Internet 340. Venue device 310, LMS server 360, logging server 370, customer service device 380, and/or third-party server 350 can communicate with a plurality of different ticket servers 330. Ticket server 330 can communicate with a plurality of different venue devices 310, LMS servers 360, logging servers 370, customer service devices 380, and/or third-party servers 350. A plurality of different ticket servers 330 can communicate among themselves and can be considered herein as being the same as a single ticket server 330.

Ticket server 330 can communicate with venue device 310 to obtain information about the venue. For example, ticket server 330 can communicate with venue device 310 to obtain information regarding the scheduling of events at the venue and regarding features of the venue. The features of the venue can be dependent upon the events of the venue, e.g., the features of the venue can vary from event to event.

Venue device 310 can be a computer, a server, a computing tablet, or a mobile device, as examples. Venue device 310 can have processing circuitry such as processor 312 and storage such as memory 311. Processor 312 can execute a software program stored in memory 311 for providing information regarding events scheduled to be at the venue and regarding seating at the venue for each scheduled event. Venue device 310 can provide the information to the ticket server, to LMS server 360, and/or to a user device such as user device 320.

Third party servers such server 350 may include, for example, a social media server that hosts one or more social networking accounts (e.g., a social networking account for a user of user device 320) and/or an email server that hosts email services (e.g., an email account for the user). A user may use user device 320 to access a social networking site that is hosted by one of servers 350, to send, store, and receive emails or other electronic communications on an email account that is hosted by one of servers 350, and/or to access other services on one of servers 350. Third party server 350 can be a computer, a server, a computing tablet, or a mobile device, as examples. Server 350 can have processing circuitry such as processor 354 and storage such as memory 352.

In one embodiment, servers 350 and/or 310 can be omitted if ticket server 330 has the information needed for buying, tracking, and selling of tickets. For example, ticket server 330 may have a database of available tickets and information about the tickets and venues that enables ticket server 330 to provide the necessary information to a user for selling and/or purchasing tickets to events at venues.

Generally, venue device 310, user device 320, third-party server 350, LMS server 360, logging server 370, customer service device 380, and ticket server 330 can perform functions discussed herein. That is, at least to some extent, a function that is discussed herein as being performed via a particular one of these devices can be performed by a different one of these devices, by a combination of these devices, and/or by other devices.

Venue device 310, user device 320, third-party server 350, other mobile devices, LMS server 360, logging server 370, customer service device 380, and server 330 can communicate with one another via a network, such as the Internet 340.

Venue device 310, user device 320, third-party server 350, other mobile devices, LMS server 360, logging server 370, customer service device 380, and server 330 can communicate with one another via one or more networks, such as local area networks (LANs), wide area networks (WANs), cellular telephone networks, and the like. Venue device 310, user device 320, third-party server 350, other mobile devices, LMS server 360, logging server 370, customer service device 380, and server 330 can communicate with one another, at least partially, via one or more near field communications (NFC) methods or other short range communications methods, such as infrared (IR), Bluetooth, WiFi, and WiMax.

When a user wishes to shop for tickets online, sell tickets online, check in to an event venue online, access electronic tickets online, provide location information online, or track tickets online (as examples), the user can open an online ticket seller's website or can access the ticket seller using an application such as app 325. The user can open the ticket seller's website using user device 320, for example. The ticket seller's website can be hosted on ticket server 330, LMS server 360, or on any other server or device.

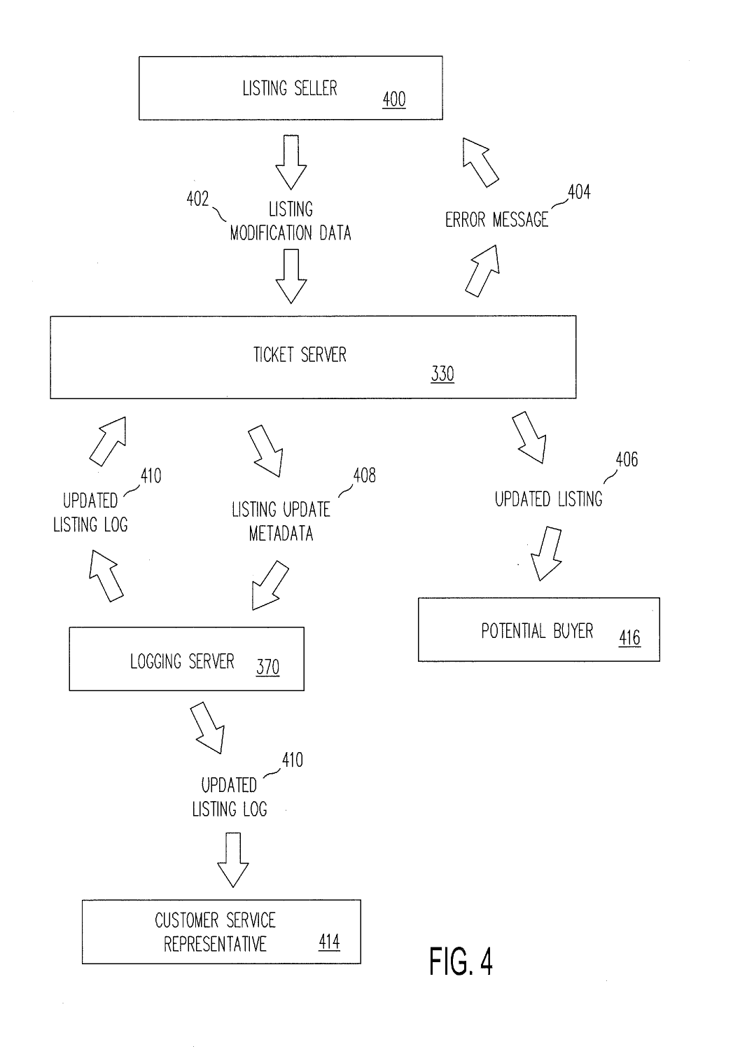

FIG. 4 is a flow diagram showing how data may be exchanged between a ticket server, a logging server, a seller, a buyer, and/or a customer service representative in a ticket selling, buying, and tracking operation in accordance with an embodiment. A ticket owner such as listing seller 400 (e.g., a ticket seller that has listed one or more tickets for sale in an online ticket listing with ticket server 330) may wish to update a ticket listing for the tickets.

As shown in FIG. 4, listing seller 400 may provide listing modification data 402 to ticket server 330. Listing modification data may include one or more commands or requests for modifying a listing (e.g., by changing the price of a ticket, changing the end date of a listing, changing the delivery options, changing the quantity of tickets, etc.). In response to receiving the listing modification data, the ticket server may generate an updated listing 406. The updated listing 406 may be provided to a potential buyer such as potential buyer 416.

In response to receiving the listing modification data, the ticket server may also generate listing update metadata 408. The listing update metadata may be provided to logging server 370. Listing update metadata 408 may be a log entry that describes the listing modification that was made based on the listing modification data. For example, the listing update metadata may be a table entry that includes a time the modification was made, an identity of the user that made the modification (e.g., the listing seller), the type of modification, notes about the modification, etc. The logging server may update a listing log that is stored on the logging server in connection with the listing seller's listing by adding the listing update metadata to the listing log. In one embodiment, listing update metadata 408 may be provided to logging server 370 in a format that is suitable for addition to the listing log. In another embodiment, logging server 370 may perform processing operations on the received listing update metadata prior to or during an update to a listing log.

An updated listing log such as updated listing log 410 may be provided to ticket server 330 and/or a customer service representative such as customer service representative 414. For example, if the listing seller contacts customer service representative 414 regarding a listing, customer service representative 414 may access the updated listing log and use the information in the updated listing log to resolve a complaint by the listing seller. In some usage scenarios, the listing log may indicate that an erroneous change to the listing was made by the seller and the seller may drop a complaint. In other usage scenarios, the listing log may indicate that an erroneous change to the listing was made by the ticket server without input from the seller and the seller may receive a refund or other suitable compensation for the error.

In some usage scenarios, the ticket server 330 may use a listing log such as updated listing log 410 to detect an error in a listing change that the listing seller is attempting to make and provide an error message such as error message 404 to the listing seller. In one embodiment, error message 404 can be provided to listing seller 400 before any listing update is made. In this way, erroneous changes to listings can be prevented. In one usage scenario, if listing seller has already provided, for example, six tickets for sale to a LMS center and subsequently attempts to reduce the number of available tickets on a listing associated with those tickets to five tickets, the ticket server can determine from the listing log that six tickets are currently available at the LMS center and alert the listing seller to the error prior to updating the listing.

In some embodiments, a user such as listing seller 400 may be provided with access to some or all of a listing log such as updated listing log 410. For example, the listing log may be partially or completely displayed along with the listing, a link to the listing may be provided in the listing, or the user may otherwise be provided with access to some or all of the listing log. For example, in one embodiment, the user may be able to view a portion of a listing log that contains actions taken by that user. For example, a seller may be able to see the date, time, and listing details for the listing creation by the seller, for a listing update by the seller, or other seller actions. By providing a customer with access to some or all of the listing log in this way, customer calls to customer service representative 414 may be reduced as many questions about a listing can be answered by reviewing the listing log. This can reduce the workload on a customer service center and/or allow the customer service center to attend to other customer matters.

A logging server such as logging server 370 may be used to track changes to a ticket listing as described in connection with FIG. 4 and/or to track other changes associated with the buying and selling of tickets such as changes in the status of the physical tickets. For example, logging server 370 may track the status of tickets in connection with a ticket sales operation involving a last minute services center.

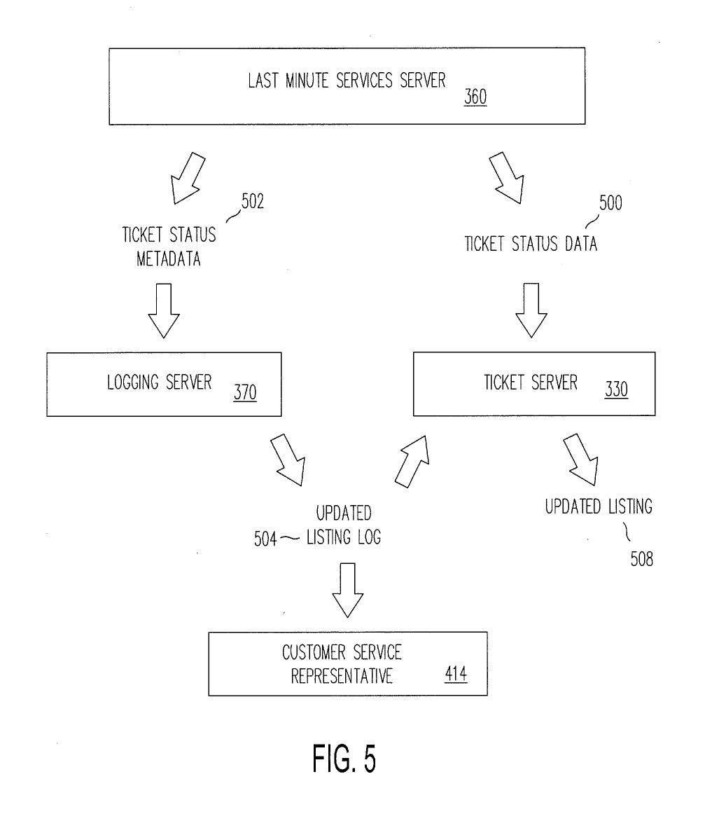

FIG. 5 is a flow diagram showing how data may be exchanged between a ticket server, a logging server, an LMS server, and/or a customer service representative in a ticket selling, buying, and tracking operation in accordance with an embodiment.

As shown in FIG. 5, LMS server 360 may provide ticket status data 500 to ticket server 330. Ticket status data 500 may include data associated with a notice to a seller to provide tickets to an LMS center, a receipt of tickets at an LMS center, a ticket sale, and/or a providing of tickets to a buyer (as examples). In response to receiving the ticket status data, the ticket server may generate an updated listing 508. The updated listing 508 may include the status of the tickets. For example, the updated listing may show that the tickets are currently available at a particular LMS center and the location (e.g., the address) of that LMS center. The updated listing 508 may be provided to one or more potential buyers that are shopping for tickets for an event.

In response to receiving the ticket status data, the ticket server may also generate listing update metadata to be provided to a logging server. However, this is merely illustrative. As shown in FIG. 5, in some embodiments, LMS server 360 may generate ticket status metadata 502 in addition to the ticket status data 500 and provide the ticket status metadata 502 directly to logging server 370. Ticket status metadata 502 may be a log entry that describes a change in the status of physical tickets as reflected in the ticket status data. For example, the ticket status metadata may be a table entry that includes a time the ticket status was updated, an identity of the user that made the update (e.g., the listing seller or the LMS center), and/or the type of status update (e.g., a receipt of tickets at the LMS center, a notification to a seller to provide tickets to an LMS center, etc.). The logging server may update a listing log that is stored on the logging server in connection with the listing seller's listing by adding the ticket status metadata to the listing log. In one embodiment, ticket status metadata 502 may be provided to logging server 370 in a format that is suitable for addition to the listing log. In another embodiment, logging server 370 may perform processing operations on the received ticket status metadata prior to or during an update to a listing log.

An updated listing log such as updated listing log 504 may be provided to ticket server 330, a customer service representative such as customer service representative 414, or another user such as a seller. For example, if the listing seller contacts customer service representative 414 regarding a listing, customer service representative 414 may access the updated listing log 504 and use the information in the updated listing log to resolve a complaint by the listing seller.

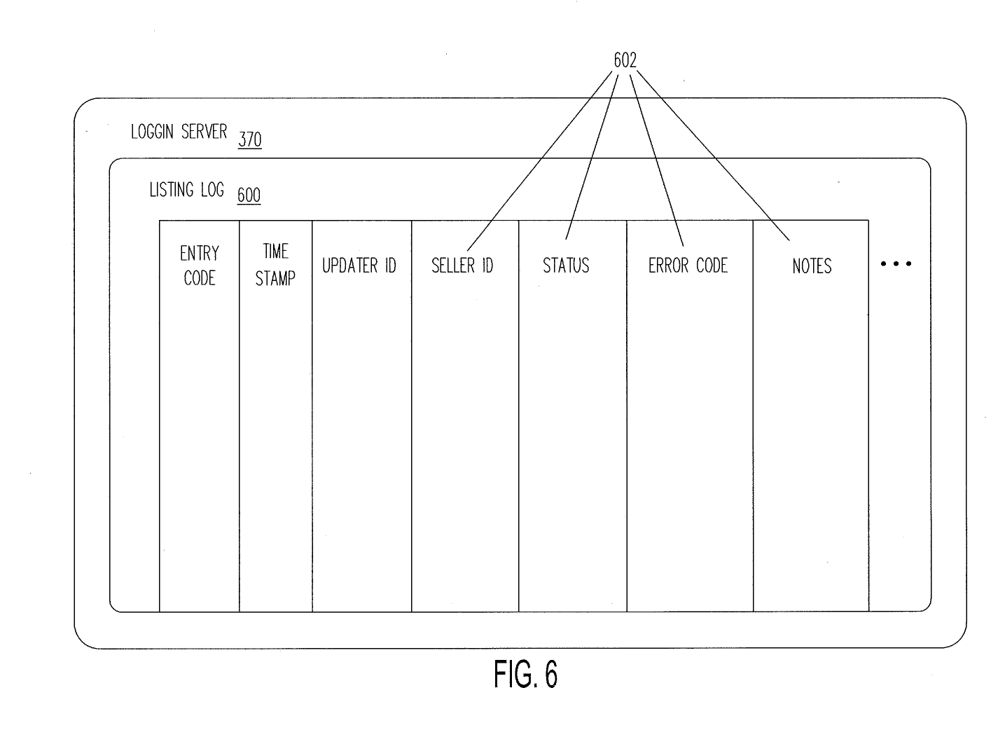

FIG. 6 shows an example of a listing log that may be stored, maintained and/or updated by a logging server such as logging server 370 according to an embodiment. As shown in FIG. 6, a listing log such as listing log 600 may include data arranged in columns 602, each column containing data for one or more log entries. Each log entry may correspond to an update associated with a ticket and/or a ticket listing and may include data in one or more of columns 602. However, the arrangement of data in listing log 600 is merely illustrative. It should be appreciated that data entries in a listing log may be arranged and/or stored in any suitable way for tracking the creation, update, deletion, addition, or other change to a listing for tickets.

In the embodiment shown in FIG. 6, each entry in a listing log 600 includes one or more of an entry code, a time stamp, an updater identity (ID), a seller identity, a status, an error code, notes, or other information associated with a listing. An entry code may be a unique identifier (e.g., a numeric code) that identifies a particular entry in listing log 600. A time stamp may include a date and/or a time associated with the entry. An updater ID may be an identifier that identifies the source of the update for that entry. For example, the updater ID may be an email address of a seller, a ticket server internet protocol address, an LMS server internet protocol address, an employee number of a customer service representative, an identifier (e.g., an employee number or an email address) of a last minute services representative that received a ticket, or any suitable identifying information that indicates who or what updated a ticket listing and/or a ticket status.

A seller ID may identify the seller for the listing (e.g., a seller email address or username). A status may indicate the status of the tickets and/or the listing at the time the entry in the listing log was made. For example, the status may indicate that a listing was active and tickets were located at an LMS center when a particular entry in the listing log was made. The status may indicate the particular LMS center or other location at which the tickets were located at the time of the entry in the listing log. An error code may be a coded identifier of a type of error that was detected by a ticket server, a customer service agent, an LMS server, or the like. An error code may, for example, indicate that an error message associated with an erroneous deletion of tickets from a ticket listing was sent to a seller.

Notes in listing log 600 may include additional data provided in a listing log entry automatically by a server and/or manually by an operator such as a customer service representative. For example, if a seller contacts a customer service representative and discusses a particular entry in a listing log with the customer service representative, the customer service representative can add a note to that entry describing the discussion. In various embodiments, each entry in a listing log can include any or all of an entry code, a time stamp, an updater ID, a seller ID, a status, an error code, notes, or other information associated with a listing.

A separate listing log entry in listing log 600 may be generated and stored for each and every action associated with a listing, a ticket, and/or a seller. In some embodiments, listing log 600 may include entries associated with a seller. For example, a customer service center, ticket server 330 or another device, server, or agent of an online ticket marketplace may generate automatic and/or personal emails to a seller at various stages in a ticket listing and sale process. An entry in a listing log may memorialize each sent and/or received email. In one embodiment, an entry in listing log 600 for an email may include the sender, the receiver, copied parties, the time, the date, and the text or other details of the email. In another embodiment, a file containing the email or a link to the email may be embedded within log 600. In another embodiment, an entry in listing log 600 for an email may include summary details of the email without saving the text. However, these embodiments are merely illustrative. In general, listing log 600 may store emails or email data in any suitable form.

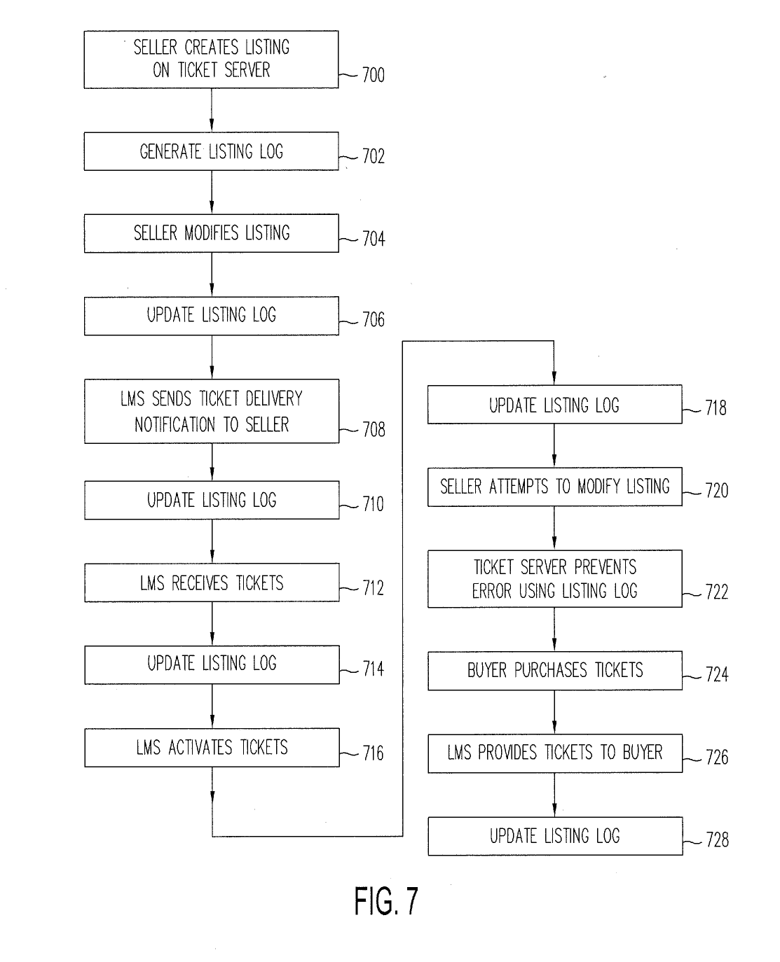

Various operations that may be performed by a system such as system 100 of FIG. 1 and/or any or all of the servers and/or devices of FIG. 3 during a ticket sales, purchase, and tracking operation are shown in FIG. 7.

At step 700, a seller may create a listing for one or more tickets for a ticketed event on a ticket server.

At step 702, a listing log may be generated for the listing. Generating the listing log may include generating the listing log at a ticket server and providing the listing log to a logging server, generating and storing the listing log at the ticket server, and/or instructing a logging server to generate a listing log for tracking updates associated with the created listing.

At step 704, the seller may modify the listing. For example, the seller may change the price of one or more tickets, change the number of tickets that are available for purchase, change the end time of the ticket listing or make any other suitable changes to the ticket listing.

At step 706, the ticket server and/or the logging server may update the listing log responsive to the listing modification. For example, the logging server may generate an entry in the listing log that describes the listing update in response to receiving listing update metadata from the ticket server.

At step 708, a last minute services server may send ticket delivery information such as a ticket delivery notification to the seller. The ticket delivery information may include directions for providing physical tickets to a particular LMS center.

At step 710, the LMS server and/or the logging server may update the listing log responsive to a ticket status update such as the LMS delivery notification. For example, the logging server may generate an entry in the listing log that describes the ticket status update in response to receiving ticket status metadata associated with the ticket delivery notification from the LMS server.

At step 712, the tickets may be received at the LMS center. For example, the tickets may be delivered by a courier or a mail carrier and/or dropped off by the seller.

At step 714, the LMS server and/or the logging server may update the listing log responsive to the receipt of the tickets at the LMS center. For example, the logging server may generate an entry in the listing log that describes the ticket status update in response to receiving, from the LMS server, ticket status metadata associated with the receipt of the tickets.

At step 716, the LMS server may activate a ticket listing in response to receiving the tickets. The LMS server may activate the ticket listing directly or may send instructions to the ticket server to update the listing.

At step 718, the LMS server, the ticket server, and/or the logging server may update the listing log responsive to the ticket activation. For example, the logging server may generate an entry in the listing log that describes the ticket status update in response to receiving, from the LMS server, ticket status metadata associated with the activation.

At step 720, the seller may attempt to make an additional modification to the listing. The additional modification may be an erroneous modification. For example, the ticket server may receive a listing update request from a seller attempting to reduce the number of tickets that are for sale while the physical tickets are actually for sale at the LMS center.

At step 722, the ticket server may prevent an error such as an erroneous listing update using the listing log. For example, the ticket server may detect, using the listing log, that the listing update request includes an error (e.g., that the listing update request includes a request to reduce the available number of tickets to less than six while the listing log indicates that six tickets are available for sale at a LMS center) and prevent the seller from making an erroneous listing update (e.g., reducing the number of tickets for sale on the listing to less than 6).

At step 724, a buyer may purchase the tickets. The buyer may purchase the tickets online using the ticket server for later pickup at the LMS center or the buyer may purchase the tickets directly from the LMS center (as examples).

At step 726, the LMS center may provide the tickets to the buyer.

At step 728, the LMS server and/or the logging server may update the listing log responsive to the purchase of the tickets and/or the delivery of the tickets to the buyer. For example, the logging server may generate an entry in the listing log that describes the ticket status update in response to receiving, from the LMS server, ticket status metadata associated with the delivery of the tickets to the buyer.

In this way, each step in a ticket sale operation can be tracked, thereby reducing the likelihood of errors during the ticket sale operation and/or increasing the likelihood of an efficient and amiable resolution to any dispute during or after the ticket sale operation.

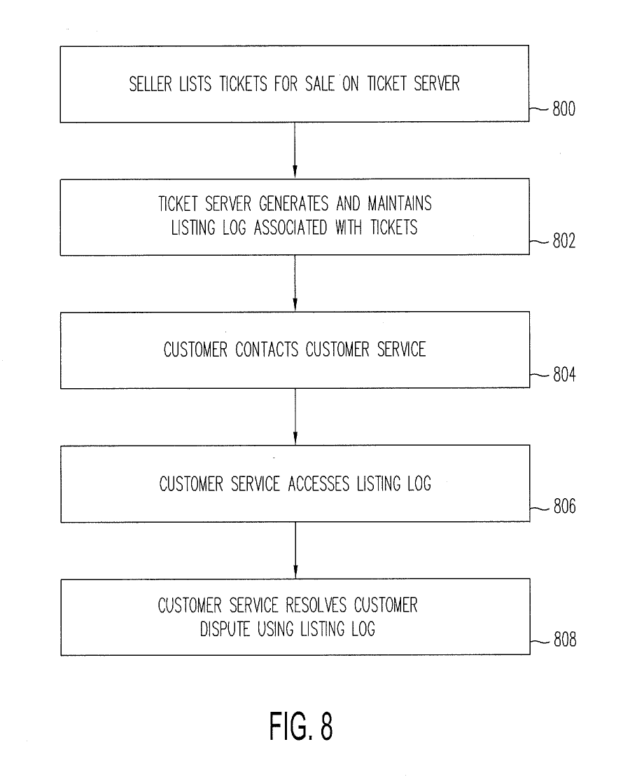

Illustrative steps that may be included in an example usage scenario in which a dispute is resolved using a listing log are shown in FIG. 8.

At step 800, a seller may list one or more tickets for sale on a ticket server as described herein.

At step 802, the ticket server (and/or an associated logging server) may generate and maintain a listing log associated with the listed tickets.

At step 804, a customer such as the seller, a potential buyer, or a buyer of the tickets may contact a customer service center associated with the ticket server. The customer may have a complaint, a question, or a dispute that they wish to address with customer service.

At step 806, a customer service representative and/or an automatic customer server device may access the listing log. The listing log may include information that answers one or more questions and/or resolves confusion on the part of the customer, the customer service representative, an LMS agent, or other person involved in a ticket listing and sale operation in connection.

At step 808, the customer service representative and/or device may resolve a dispute by the customer using the listing log.

The processes described in connection with FIGS. 7 and 8 may be performed in any suitable order and repeated any suitable number of times to facilitate tracking and dispute resolution operations associated with the listing, sale, and/or purchase of one or more tickets.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system, comprising:
a hardware memory configured to store a listing log associated with a listing of tickets for a ticketed event; and
one or more processors coupled to the hardware memory, wherein the one or more processors are configured to:
generate a listing of at least one ticket that is available for purchase from a seller;
generate a listing log for tracking information associated with the listing and the at least one ticket;
receive listing modification data from the seller; and
modify the listing and the listing log based on the listing modification data.

2. The system defined in claim 1, wherein the one or more processors are further configured to:
receive ticket status data; and
modify the listing log based on the ticket status data.

3. The system defined in claim 2, wherein the one or more processors are further configured receive the ticket status data from a last minute services server.

4. The system defined in claim 3, wherein the one or more processors are further configured to receive ticket status metadata from the last minute services server and to modify the listing log based on the ticket status data by modifying the listing log using the ticket status metadata.

5. The system defined in claim 4, wherein the ticket status data comprises data that indicates that the at least one ticket was received at a last minute services center associated with the last minute services server and wherein the ticket status metadata comprises a time at which the at least one ticket was received at the last minute services center.

6. The system defined in claim 5, wherein the ticket status metadata further comprises a delivery method by which the at least one ticket was received at the last minute services center.

7. The system defined in claim 2, wherein the one or more processors are further configured to provide the listing log to a customer service device.

8. A method, comprising:
generating, electronically by one or more processors, a listing of at least one ticket that is available for purchase from a seller;
generating, electronically by the one or more processors, a listing log for tracking information associated with the listing and the at least one ticket;
receiving, electronically by the one or more processors, listing modification data from the seller; and
modifying, electronically by the one or more processors, the listing and the listing log based on the receiving.

9. The method defined in claim 8, further comprising:
receiving ticket status data; and
modifying the listing log based on the receiving of the ticket status data.

10. The method defined in claim 8, further comprising:
receiving a listing update request from the seller;
detecting an error in the listing update request using the listing log; and
preventing an erroneous listing update based on the detecting.

11. The method defined in claim 8, further comprising:
receiving ticket status metadata from a last minute services server; and
modifying the listing log based on the receiving of the ticket status metadata.

12. The method defined in claim 11, wherein the ticket status metadata comprises a time at which the at least one ticket was received at the last minute services center.

13. The method defined in claim 12, wherein the ticket status metadata further comprises a delivery method by which the at least one ticket was received at the last minute services center.

14. The method defined in claim 8, further comprising providing access to the listing log to a customer service representative.

15. A non-transitory machine-readable medium having a plurality of machine-readable instructions which, when executed by one or more processors of a server, are adapted to cause a server to perform a method comprising:
generating a listing of at least one ticket that is available for purchase from a seller;
generating a listing log for tracking information associated with the listing and the at least one ticket;
receiving listing modification data from the seller; and
modifying the listing and the listing log based on the receiving.

16. The non-transitory machine-readable medium defined in claim 15, wherein the method further comprises:
receiving ticket status data; and
modifying the listing log based on the receiving of the ticket status data.

17. The non-transitory machine-readable medium defined in claim 16, wherein the receiving of the ticket status data comprises receiving the ticket status data from a last minute services server.

18. The non-transitory machine-readable medium defined in claim 17, wherein the method further comprises:
receiving ticket status metadata from the last minute services server; and
modifying the listing log based on the ticket status data by modifying the listing log using the ticket status metadata.

19. The non-transitory machine-readable medium defined in claim 18, wherein the ticket status data comprises data that indicates that the at least one ticket was received at a last minute services center associated with the last minute services server and wherein the ticket status metadata comprises an identifier of a last minute services representative that received the at least one ticket.

20. The non-transitory machine-readable medium defined in claim 15, wherein the method further comprises providing the listing log to a customer service representative.
